(19) United States
(12) Patent Application Publication
(10) Pub. No.: US 2025/0274305 A1
(43) Pub. Date: Aug. 28, 2025

(54) CONTROL DEVICE, CONTROL SYSTEM, CONTROL METHOD, AND RECORDING MEDIUM

(71) Applicant: Mitsubishi Electric Corporation, Tokyo (JP)

(72) Inventors: Takayoshi TONOMURA, Tokyo (JP); Takamitsu YAMADA, Tokyo (JP); Shinya SUGINO, Tokyo (JP); Morimasa MATSUDA, Tokyo (JP)

(21) Appl. No.: 18/857,504

(22) PCT Filed: Jun. 22, 2022
(86) PCT No.: PCT/JP2022/024921

§ 371 Date: Oct. 17, 2024

(51) Int. Cl. H04L 12/28

(52) U.S. Cl. CPC H04L 12/2807; H04L 12/2818

(57) ABSTRACT

A control device includes an address resolution protocol (ARP) table storage to store ARP table information associating a media access control (MAC) address with an Internet protocol (IP) address assigned to an appliance in a network including the appliance, a MAC address identifier to identify the MAC address of the appliance based on the ARP table information, an appliance message transmitter to transmit an appliance message to the appliance using the identified MAC address, and a MAC address acquirer to transmit, to the appliance corresponding to a combination of the IP address and the MAC address not included in the ARP table information, an ARP request requesting transmission of MAC address information to acquire the MAC address information of the appliance, and add the MAC address information to the ARP table information.

### CROSS-REFERENCE TO RELATED APPLICATION

This application is a U.S. national stage application of PCT/JP2022/024921 filed on Jun. 22, 2022, the contents of which are incorporated herein by reference.

### TECHNICAL FIELD

The present disclosure relates to a control device, a control system, a control method, and a recording medium.

### BACKGROUND

A known energy management system (EMS) communicates with appliances through a network using a dynamic address dynamically assigned to each appliance (see, for example, Patent Literature 1). The EMS receives, from an appliance, an instance list including the type of the appliance. The instance list is repeatedly transmitted at least within a predetermined period through broadcasting or multicasting. The EMS transmits an identification information request message to the appliance through broadcasting or multicasting, and receives an identification information notification message transmitted from the appliance using a transmission source address of the information request message. The EMS then identifies the type of the appliance based on the instance list received from the appliance, identifies the identification information of the appliance based on the identification information notification message, and manages the identified type of the appliance and the identification information in a manner associated with the latest dynamic address.

### PATENT LITERATURE

Patent Literature 1: Unexamined Japanese Patent Application Publication No. 2019-71638

A technique is now available for controlling, using a control device, an appliance by communication through a network without being affected by dynamic address updates. The technique includes managing a control target appliance in a manner associated with a static media access control (MAC) address assigned to the control target appliance. In this case, when controlling an appliance that is not registered with the address resolution protocol (ARP) for the appliances managed by the control device, a MAC address of the appliance is to be acquired from the appliance. In particular, when an appliance is newly connected to a network with the system described in Patent Literature 1, the appliance transmits an instance list to the EMS. However, the MAC address of the appliance is not registered with the ARP. The EMS receiving the instance list thus cannot accurately acquire the MAC address of the source appliance from the instance list.

### SUMMARY

Under such circumstances, an objective of the present disclosure is to provide a control device, a control system, a control method, and a program for appropriately managing a control target appliance using a static address assigned to the target appliance.

To achieve the above objective, a control device according to an aspect of the present disclosure is a control device for controlling an appliance by transmitting, to the appliance, control information for controlling the appliance using a static address specific to the appliance in a network including the appliance. The control device includes a table storage to store table information associating the static address with a dynamic address assigned to the appliance in the network including the appliance, an appliance information storage to store, in a manner associated with static address information indicating the static address and being specific to the appliance, type information indicating a type of the appliance and appliance identification information identifying the appliance in an application layer, and processing circuitry to identify the static address of the appliance based on the table information, transmit an appliance message to the appliance using the identified static address, transmit, to the appliance corresponding to a combination of the dynamic address and the static address not included in the table information, a static address request requesting transmission of the static address information to acquire the static address information, and add the static address information to the table information, acquire the appliance message transmitted from the appliance, determine whether the acquired appliance message is an update notification indicating assignment of a new dynamic address to the appliance, generate the control information based on at least one of the type information or the appliance identification information, and update the type information, the appliance identification information, and the static address information that are stored in the appliance information storage. The update notification includes the type information and the appliance identification information. The processing circuitry transmits the static address request to the appliance that is a transmission source of the update notification to acquire the static address information from the appliance, and adds the static address information to the table information, transmits the control information to the appliance using the static address information associated with the type information and the appliance identification information corresponding to the generated control information and stored in the appliance information storage, and when the update notification is acquired, causes the appliance information storage to store, in a manner associated with one another, the type information and the appliance identification information included in the acquired update notification and the acquired static address information.

In the structure according to the above aspect of the present disclosure, the static address acquirer transmits, to the appliance corresponding to the combination of the dynamic address and the static address not included in the table information that associates the static address with the dynamic address assigned to the appliance, the static address request to acquire the static address information, and adds the static address information to the table information. This structure appropriately manages a control target appliance using the static address assigned to the control target appliance.

### BRIEF DESCRIPTION OF DRAWINGS

FIG. 1 is a schematic diagram of a control system according to Embodiment 1 of the present disclosure;

FIG. 2 is a block diagram of the control system according to Embodiment 1, illustrating the hardware configuration;

FIG. 3 is a functional block diagram of a control device according to Embodiment 1;

FIG. 4 is a table illustrating an example of information stored in an appliance information storage in Embodiment 1;

FIG. 5 is a sequence diagram illustrating the operation of the control system according to Embodiment 1;

FIG. 6 is a flowchart of an example appliance control process performed by the control device according to Embodiment 1;

FIG. 7 is a schematic diagram of a control system according to Embodiment 2 of the present disclosure;

FIG. 8 is a block diagram of the control system according to Embodiment 2, illustrating the hardware configuration;

FIG. 9 is a functional block diagram of a cloud server and a control device according to Embodiment 2;

FIG. 10 is a table illustrating an example of information stored in an appliance information storage in Embodiment 2;

FIG. 11 is a sequence diagram illustrating the operation of the control system according to Embodiment 2;

FIG. 12 is a sequence diagram illustrating the operation of the control system according to Embodiment 2; and

FIG. 13 is a flowchart of an example appliance control process performed by the control device according to Embodiment 2.

### DETAILED DESCRIPTION

### Embodiment 1

A control device according to an embodiment of the present disclosure is described below with reference to the accompanying drawings. The control device according to the present embodiment controls an appliance by transmitting, to the appliance, control information for controlling the appliance using a static address specific to the appliance in a network including the appliance. The control device includes a table storage, a static address identifier, an appliance message transmitter, and a static address acquirer. The table storage stores table information associating the static address assigned to the appliance with a dynamic address in the network including the appliance. The static address identifier identifies the static address of the appliance based on the table information. The appliance message transmitter transmits an appliance message to the appliance using the identified static address. The static address acquirer transmits, to an appliance corresponding to a combination of the dynamic address and the static address not included in the table information, a static address request requesting transmission of static address information indicating the static address, acquires the static address information, and adds the static address information to the table information.

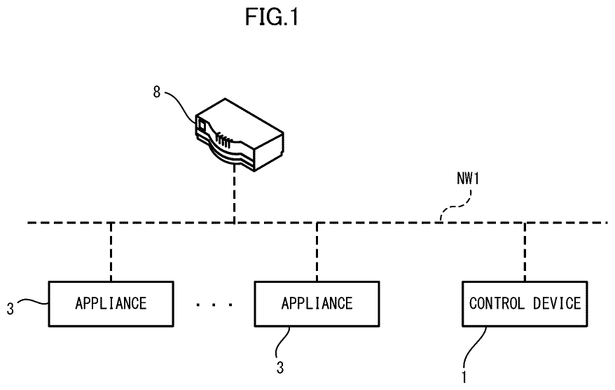

As illustrated in FIG. 1, a control device 1 according to the present embodiment is connected to a network NW1 to which appliances 3 and a router 8 are connected. The appliances 3 and the control device 1 can communicate with each other through the network NW1. The network NW1 is, for example, a wireless local area network (LAN). Each appliance 3 includes an address acquirer (not illustrated) that transmits a connection request to the router 8 to acquire Internet protocol (IP) address information from the router 8, and an address storage (not illustrated) that stores the IP address information acquired by the address acquirer from the router 8. The appliance 3 further includes an address resolution protocol (ARP) responder (not illustrated). The ARP responder transmits, when acquiring an ARP request from the router 8 and an appliance connected to the NW1 or the control device 1, an ARP reply including the IP address information assigned to the appliance 3 and media access control (MAC) address information of the appliance 3 to the router 8. The appliance 3 can store ARP table information associating the IP addresses assigned to the other appliances 3 or the control device 1 and the MAC addresses of the other appliances 3 or the control device 1. When the appliance 3 is newly connected to the network NW1 and an IP address is assigned to the appliance 3 or when the IP address expires and the IP address of the appliance 3 is updated, the appliance 3 generates an update notification indicating that the IP address is updated and transmits the update notification to the control device 1. The update notification includes type information indicating the type of the appliance and an identification number identifying the appliance in an application layer. The update notification corresponds to, for example, an instance list notification defined in ECHONET Lite (registered trademark). The identification number is, for example, appliance identification information preassigned by a manufacturer of the appliance 3 based on the format defined in ECHONET Lite (registered trademark). The identification number corresponding to the instance list notification is broadcast through the router 8, and can be received by all the appliances 3 and the control device 1 connected to the NW1. The appliance 3 can periodically generate appliance state information indicating the state of the appliance 3 at predetermined intervals, and transmit the generated appliance state information to the control device 1.

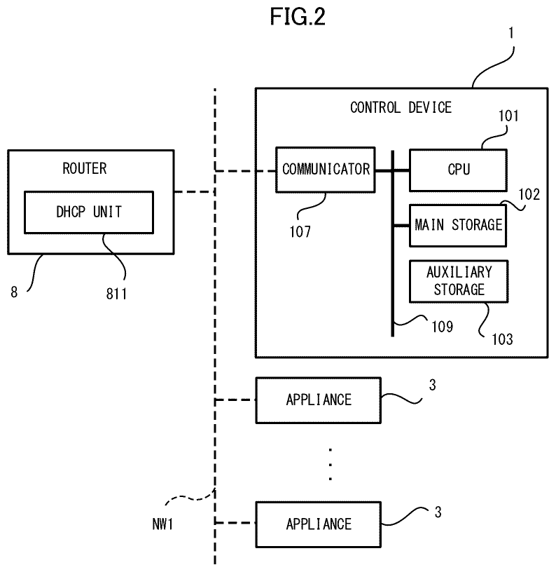

As illustrated in FIG. 2, the router 8 includes, as a functional component, a dynamic host configuration protocol (DHCP) unit 811, and functions both as a normal router and as a DHCP server. When receiving a connection request from an appliance 3 or the control device 1, the DHCP unit 811 identifies, from multiple predetermined IP addresses, an IP address to be assigned to the appliance 3 or the control device 1 as a transmission source of the connection request. The DHCP unit 811 then transmits the IP address information indicating the identified IP address to the appliance 3 or the control device 1 as a transmission source.

Referring back to FIG. 2, the control device 1 includes a central processing unit (CPU) 101, a main storage 102, an auxiliary storage 103, a communicator 107, and a bus 109 that connects the components. The main storage 102 is a volatile memory, such as a random-access memory (RAM), and used as a work area for the CPU 101. The auxiliary storage 103 includes a nonvolatile memory, such as a semiconductor memory, and functions as a read-only memory (ROM) or a storage to store programs for implementing the functions of the control device 1. The communicator 107 includes, for example, a wireless module and wirelessly communicates with the appliances 3 and the router 8. The wireless module includes a signal generation circuit that generates a radio signal, an antenna, and a data link layer that communicates based on, for example, a communication protocol of IEEE802.11 versions.

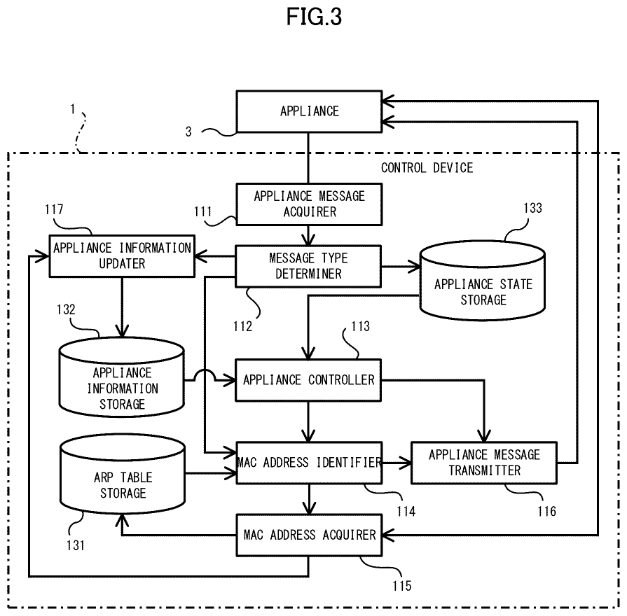

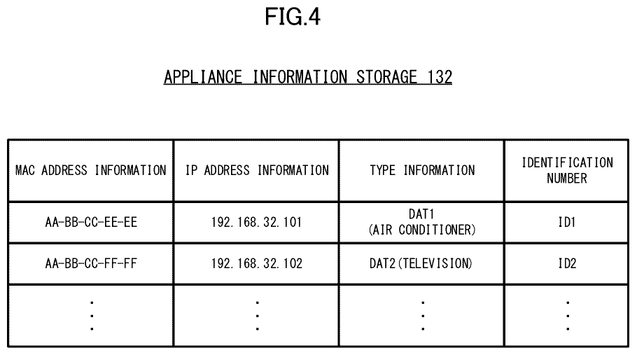

In the control device 1, the CPU 101 reads the programs stored in the auxiliary storage 103 into the main storage 102 and executes the programs. As illustrated in FIG. 3, the CPU 101 thus functions as an appliance message acquirer 111, a message type determiner 112, an appliance controller 113, a MAC address identifier 114, a MAC address acquirer 115, an appliance message transmitter 116, and an appliance information updater 117. As illustrated in FIG. 3, the auxiliary storage 103 illustrated in FIG. 2 includes an ARP table storage 131, an appliance information storage 132, and an appliance state storage 133. The ARP table storage 131 stores the ARP table information that associates an IP address assigned to the appliance 3 with a MAC address specific to the appliance 3 in the network NW1 including the appliance 3. As illustrated in, for example, FIG. 4, the appliance information storage 132 stores, in a manner associated with the MAC address information of the appliance 3, a combination of IP address information, type information indicating the type of the appliance 3, and an identification number assigned to each of the multiple appliances 3 included in the network NW1. Referring back to FIG. 3, the appliance state storage 133 stores parameter information indicating the state of each appliance 3 in a manner associated with the type information and the identification number of the appliance 3. For an appliance 3 as an air conditioner, the parameter information indicates, for example, a set temperature, a set airflow rate, and ambient temperature and humidity at a site at which the appliance 3 is installed.

When acquiring an appliance message transmitted from the appliance 3, the appliance message acquirer 111 provides, to the message type determiner 112, the acquired appliance message. The appliance message includes an update notification indicating a network update event in which the state of the network NW1 including the appliance 3 is updated. The network update event occurs when the appliance 3 is newly connected to the network NW1 and the DHCP unit 811 in the router 8 newly assigns an IP address to the appliance 3 or when the IP address of the appliance 3 expires and the DHCP unit 811 updates the IP address of the appliance 3. The appliance message also includes the appliance state information including the parameter information indicating the state of the appliance 3, the type information of the appliance 3, and the identification number of the appliance 3.

The message type determiner 112 determines whether the appliance message acquired by the appliance message acquirer 111 is an update notification indicating the assignment of a new IP address to the appliance 3. When determining that the acquired appliance message is an update notification, the message type determiner 112 provides, to the MAC address identifier 114, IP address information indicating the IP address of the appliance 3 as a transmission source of the update notification. The message type determiner 112 also extracts the type information and the identification number of the appliance 3 included in the acquired update notification and provides the extracted information to the appliance information updater 117, and also provides the

IP address information of the appliance 3 as a transmission source of the update notification to the appliance information updater 117. Additionally, when determining that the acquired appliance message is appliance state information, the message type determiner 112 extracts the above parameter information, the type information of the appliance 3, and the identification number of the appliance 3 included in the acquired appliance state information, and causes the appliance state storage 133 to store, in a manner associated with the type information and the identification number of the appliance 3, the extracted parameter information.

The appliance controller 113 generates control information based on at least one of the type information or the appliance identification information of a control target appliance 3 stored in the appliance information storage 132. The appliance controller 113 determines whether the control details of the appliance 3 are to be updated based on the appliance state information of each appliance 3 stored in the appliance state storage 133. When determining that the control details of the appliance 3 are to be updated, the appliance controller 113 generates control information corresponding to the updated control details of the appliance, and provides the generated control information to the appliance message transmitter 116 together with IP address information indicating an IP address and MAC address information indicating a MAC address assigned to the appliance 3 as a transmission destination of the control information.

When receiving the IP address information of the appliance 3 as a transmission destination of the control information from the appliance controller 113, the MAC address identifier 114 refers to the ARP table information stored in the ARP table storage 131 to identify the MAC address corresponding to the IP address indicated by the received IP address information. The MAC address identifier 114 then provides the MAC address information indicating the identified MAC address to the appliance message transmitter 116. When receiving the update notification from the message type determiner 112, the MAC address identifier 114 refers to the ARP table information stored in the ARP table storage 131 to determine whether a combination of the IP address and the MAC address of the appliance 3 as a transmission source of the update notification is included. When determining that no combination of the IP address and the MAC address of the appliance 3 as a transmission source of the update notification is included, the MAC address identifier 114 provides a MAC address acquisition request to the MAC address acquirer 115.

The MAC address acquirer 115 is a static address acquirer that, when receiving the MAC address acquisition request from the MAC address identifier 114, broadcasts an ARP request to the appliances 3 and acquires an ARP reply from an appliance 3 corresponding to the combination of the IP address and the MAC address that is not included in the ARP table information. The ARP request is a static address request that requests the appliance 3 to transmit the ARP reply including the MAC address information of the appliance 3. When acquiring the ARP reply, the MAC address acquirer 115 extracts the MAC address information included in the acquired ARP reply and adds the extracted MAC address information to the ARP table information in a manner associated with the IP address information of the appliance 3 as a transmission source of the ARP reply. The MAC address acquirer 115 also provides the extracted MAC address information to the appliance information updater 117.

When receiving the control information from the appliance controller 113, the appliance message transmitter 116 transmits the received control information to the appliance 3 as a transmission destination.

When receiving, from the message type determiner 112, the type information, the identification number, and the IP address information of the appliance 3 included in the update notification, the appliance information updater 117 causes the appliance information storage 132 to store the received information in a manner associated with the MAC address information provided from the MAC address acquirer 115.

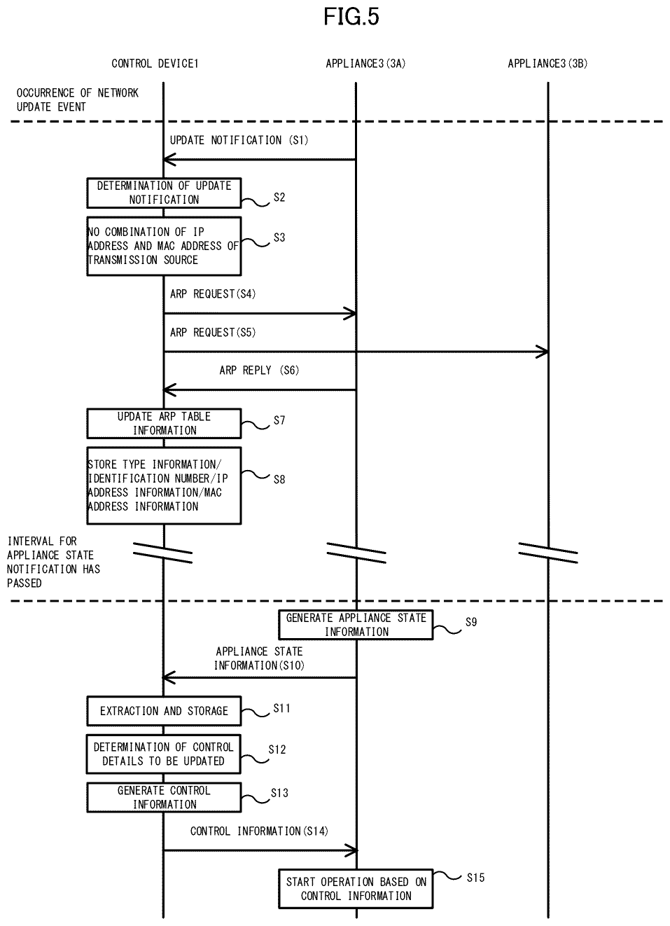

The operation of a control system according to the present embodiment is now described with reference to FIG. 5. In this embodiment, the control device 1 communicates with appliances 3A and 3B. A network update event first occurs to update the state of the network NW1 to which the appliances 3 are connected. This network update event occurs when the appliance 3A is newly connected to the network NW1 and the DHCP unit 811 in the router 8 newly assigns an IP address to the appliance 3A or when the IP address of the appliance 3A expires and the DHCP unit 811 updates the IP address of the appliance 3A. In this case, an update notification indicating that the IP address is updated is transmitted from the appliance 3A to the control device 1 (step S1). The control device 1 determines that the appliance message transmitted from the appliance 3A is an update notification (step S2). The control device 1 then refers to the ARP table information stored in the ARP table storage 131 and determines that no combination of the IP address and the MAC address of the appliance 3A as a transmission source of the update notification is included (step S3). In this case, the above ARP request is broadcast from the control device 1 to the appliance 3A and the appliance 3B (steps S4 and S5). When acquiring the ARP request, the appliance 3A as a transmission source of the update notification transmits an ARP reply including the MAC address information of the appliance 3A to the control device 1 (step S6). When acquiring the ARP reply, the control device 1 extracts the MAC address information of the appliance 3A as a transmission source of the update notification included in the acquired ARP reply, and updates the ARP table information stored in the ARP table storage 131 with the extracted MAC address information (step S7). The control device 1 then causes the appliance information storage 132 to store, in a manner associated with one another, the type information and the identification number of the appliance 3A included in the acquired update notification, the IP address information of the transmission source of the update notification, and the extracted MAC address information (step S8).

When the interval for the appliance state notification has passed as described above, the appliance 3A generates the above appliance state information (step S9) and transmits the generated appliance state information to the control device 1 (step S10). When acquiring the appliance state information, the control device 1 extracts the parameter information indicating the state of the appliance 3A included in the acquired appliance state information and causes the appliance state storage 133 to store the parameter information (step S11). The control device 1 then determines to update the control details of the appliance 3 based on the appliance state information stored in the appliance state storage 133 (step S12). In this case, the control device 1 generates control information corresponding to the updated appliance control details (step S13).

The control device 1 then transmits the generated control information to the appliance 3A using the MAC address indicated by the MAC address information of the appliance 3A (step S14). When acquiring the control information, the appliance 3A starts operation based on the acquired control information (step S15).

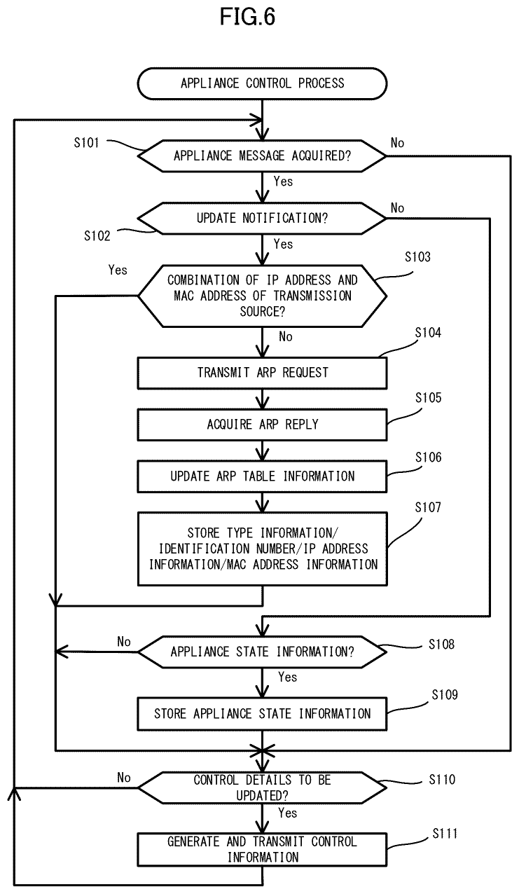

An appliance control process performed by the control device 1 according to the present embodiment is now described with reference to FIG. 6. The appliance control process starts when, for example, the control device 1 is powered on and connected to the network NW1. The appliance message acquirer 111 first determines whether an appliance message is acquired from the appliance 3 (step S101). When the appliance message acquirer 111 determines that no appliance message is acquired (No in step S101), the processing in step S110 (described later) is performed. In contrast, when the appliance message acquirer 111 determines that an appliance message is acquired (Yes in step S101), the message type determiner 112 determines whether the acquired appliance message is the update notification described above (step S102). When the message type determiner 112 determines that the appliance message is not the update notification (No in step S102), the processing in step S108 (described later) is performed. In contrast, when the message type determiner 112 determines that the appliance message is the update notification (Yes in step S102), the MAC address identifier 114 refers to the ARP table information stored in the ARP table storage 131 to determine whether any combination of the IP address and the MAC address of the appliance 3 as a transmission source of the update notification is included (step S103). When the MAC address identifier 114 determines that the combination of the IP address and the MAC address of the appliance 3 as a transmission source of the update notification is included (Yes in step S103), the processing in step S110 (described later) is performed.

When the MAC address identifier 114 determines that no combination of the IP address and the MAC address of the appliance 3 as a transmission source of the update notification is included (No in step S103), the MAC address acquirer 115 broadcasts an ARP request (step S104). The MAC address acquirer 115 thus acquires an ARP reply from an appliance 3 corresponding to the combination of the IP address and the MAC address that is not included in the ARP table information (step S105). The MAC address acquirer 115 then extracts the MAC address information included in the acquired ARP reply and updates the ARP table information by adding the extracted MAC address information to the ARP table information in a manner associated with the IP address information of the appliance 3 as a transmission source of the ARP reply (step S106). When receiving the type information and the identification number of the appliance 3 included in the update notification and the IP address information of the appliance 3, the appliance information updater 117 causes the appliance information storage 132 to store the received information in a manner associated with the MAC address information provided from the MAC address acquirer 115 (step S107). The processing in step S110 (described later) is then performed.

When determining that the appliance message is not the update notification (No in step S102), the message type determiner 112 determines whether the appliance message is appliance state information (step S108). When the message type determiner 112 determines that the appliance message is not the appliance state information (No in step S108), the processing in step S110 (described later) is performed. In contrast, when determining that the appliance message is appliance state information (Yes in step S108), the message type determiner 112 causes the appliance state storage 133 to store the appliance state information (step S109). The appliance controller 113 then refers to the appliance state information stored in the appliance state storage 133 to determine whether the control details of the appliance 3 are to be updated (step S110). When the appliance controller 113 determines that the control details of the appliance 3 are not to be updated (No in step S110), the processing in step S101 is performed again. When determining that the control details of the appliance 3 are to be updated (Yes in step S110), the appliance controller 113 generates control information for updating the control details of the appliance 3 based on the appliance state information. The appliance message transmitter 116 then transmits the control information to the appliance 3 using the MAC address information of the appliance 3 as a transmission destination of the control information stored in the appliance information storage 132 (step S111). The processing in step S101 is then performed again.

As described above, in the control device 1 according to the present embodiment, the MAC address acquirer 115 transmits an ARP request to the appliance 3 corresponding to a combination of an IP address and a MAC address that is not included in the ARP table information. The ARP table information associates the IP address assigned to the appliance 3 and the MAC address specific to the appliance 3 with each other. The MAC address acquirer 115 thus acquires the MAC address information and adds the acquired MAC address information to the ARP table information. This structure appropriately manages the target appliance 3 using the specific MAC address assigned to the control target appliance 3.

### Embodiment 2

A control system according to the present embodiment differs from the system according to Embodiment 1 in that a cloud server generates control information for controlling an appliance, and transmits the control information to the control device through a wide area network. The control device controls the appliance by transmitting the control information acquired from the cloud server to the appliance using a static address specific to the appliance in a local area network including the appliance.

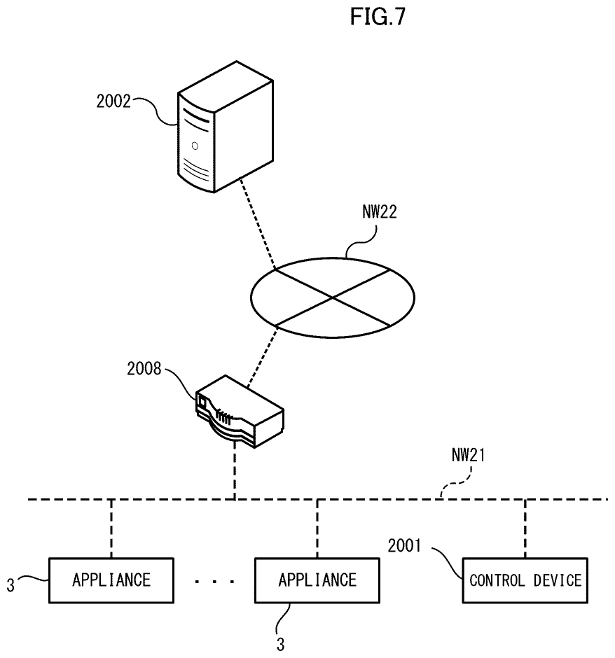

As illustrated in FIG. 7, the control system according to the present embodiment includes a cloud server 2002 and a control device 2001 that controls the operation of the appliances 3 by transmitting control information acquired from the cloud server 2002 to the appliances 3. In FIG. 7, like reference signs denote like components in Embodiment 1 in FIG. 1. The cloud server 2002 can communicate through a wide area network NW22, such as the Internet and a broadband router (hereafter referred to as BBR) 2008. The BBR 2008 includes the DHCP unit 811 described in Embodiment 1.

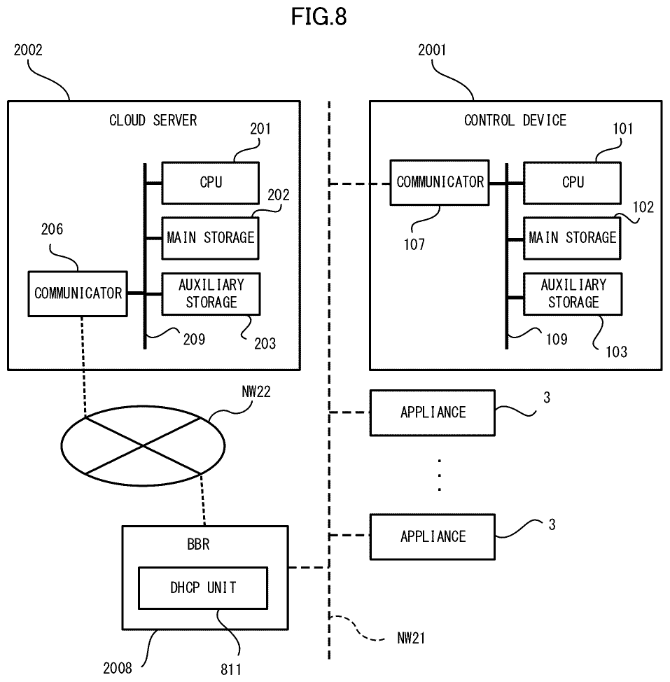

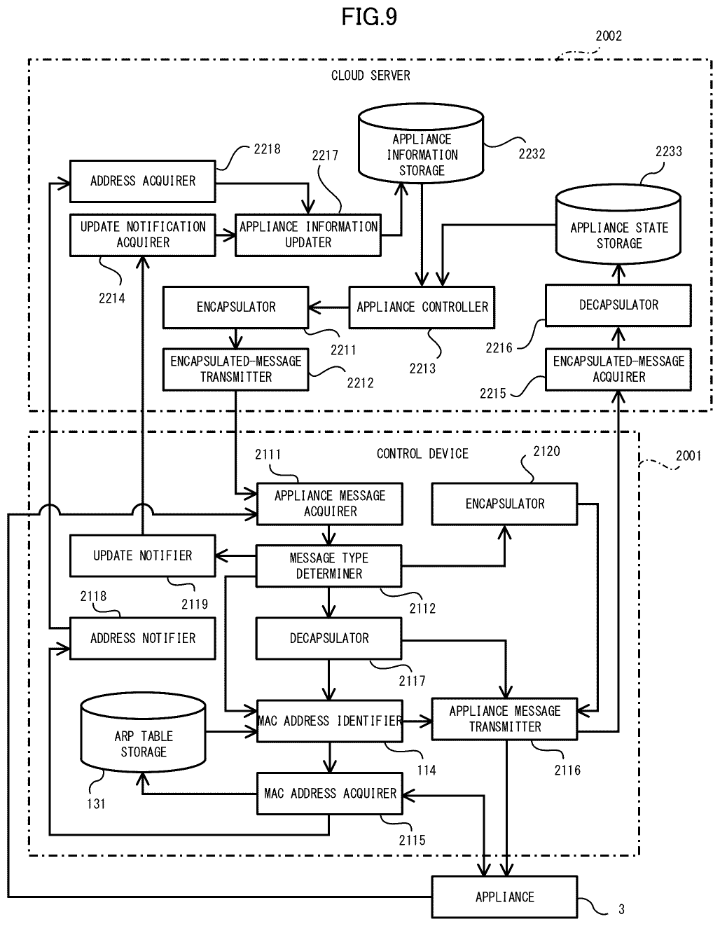

As illustrated in FIG. 8, the control device 2001 has the same hardware configuration as the control device 1 described in Embodiment 1. In FIG. 8, like reference signs denote like components in Embodiment 1 in FIG. 2. In the control device 2001, the CPU 101 reads the program stored in the auxiliary storage 103 into the main storage 102 and executes the program. As illustrated in FIG. 9, the CPU 101 thus functions as an appliance message acquirer 2111, a message type determiner 2112, a decapsulator 2117, the MAC address identifier 114, a MAC address acquirer 2115, an appliance message transmitter 2116, an address notifier 2118, an update notifier 2119, and an encapsulator 2120. In FIG. 9, like reference signs denote like components in Embodiment 1 in FIG. 3.

When acquiring an appliance message transmitted from the appliance 3 or an appliance message transmitted from the cloud server 2002 to the control device 2001, the appliance message acquirer 2111 provides, to the message type determiner 2112, the acquired appliance message. The message type determiner 2112 determines whether the appliance message acquired by the appliance message acquirer 2111 is an update notification indicating the assignment of a new IP address to the appliance 3. When determining that the acquired appliance message is an update notification, the message type determiner 2112 provides, to the MAC address identifier 114, IP address information indicating the IP address of the appliance 3 as a transmission source of the update notification. The message type determiner 2112 also extracts the type information and the identification number of the appliance 3 included in the acquired update notification and provides the extracted information to the update notifier 2119, and also provides the IP address information of the appliance 3 as a transmission source of the update notification to the update notifier 2119. Additionally, when determining that the acquired appliance message is appliance state information, the message type determiner 2112 provides the acquired appliance state information to the encapsulator 2120. When determining that the acquired appliance message is encapsulated control information or an encapsulated update notification transmitted from the cloud server 2002, the message type determiner 2112 provides the acquired control information or the update notification to the decapsulator 2117.

The update notifier 2119 generates an appliance information notification including the type information, the identification number, and the IP address information of the appliance 3 provided from the message type determiner 2112, and transmits the notification to the cloud server 2002.

When receiving the encapsulated control information or the encapsulated update notification from the message type determiner 2112, the decapsulator 2117 removes header information from the encapsulated control information or the encapsulated update notification and decapsulates the information to extract the MAC address information of the appliance 3 as a transmission destination of the control information, and the control information or the update notification. The decapsulator 2117 then provides, to the appliance message transmitter 2116, the extracted MAC address information and the extracted control information or update notification.

When receiving the MAC address acquisition request from the MAC address identifier 114, the MAC address acquirer 2115 broadcasts an ARP request to the appliances 3 and acquires an ARP reply from an appliance 3 corresponding to the combination of the IP address and the MAC address that is not included in the ARP table information. When acquiring the ARP reply, the MAC address acquirer 2115 extracts the MAC address information included in the acquired ARP reply and provides the extracted MAC address information to the address notifier 2118. The address notifier 2118 extracts, from the ARP reply provided by the MAC address acquirer 2115, the MAC address information of the appliance 3 as a transmission source of the ARP reply, generates an address notification including the extracted MAC address information, and transmits the address notification to the cloud server 2002.

When receiving the appliance state information from the message type determiner 2112, the encapsulator 2120 adds, to the received appliance state information, header information specifying the cloud server 2002 as a transmission destination and generates the state notification, and provides the state notification to the appliance message transmitter 2116.

The appliance message transmitter 2116 transmits the control information or the update notification extracted by the decapsulator 2117 to the appliance 3 as a transmission destination using the MAC address information of the appliance 3 extracted by the decapsulator 2117. When receiving the encapsulated appliance state information from the encapsulator 2120, the appliance message transmitter 2116 transmits the received appliance state information to the cloud server 2002 based on the header information.

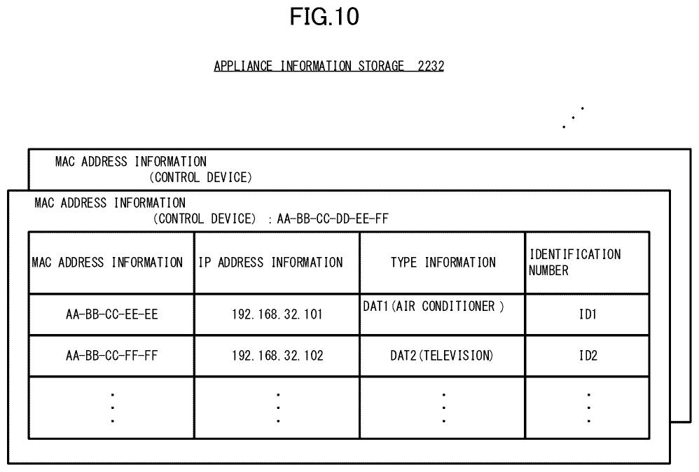

Referring back to FIG. 8, the cloud server 2002 includes a CPU 201, a main storage 202, an auxiliary storage 203, a communicator 206, and a bus 209 that connects the components. In the cloud server 2002, the CPU 201 reads the program stored in the auxiliary storage 203 into the main storage 202 and executes the program. As illustrated in FIG. 9, the CPU 201 thus functions as an encapsulator 2211, an encapsulated-message transmitter 2212, an appliance controller 2213, an update notification acquirer 2214, an address acquirer 2218, an appliance information updater 2217, an encapsulated-message acquirer 2215, and a decapsulator 2216. The auxiliary storage 203 illustrated in FIG. 8 includes an appliance information storage 2232 and an appliance state storage 2233 as illustrated in FIG. 9. As illustrated in, for example, FIG. 10, the appliance information storage 2232 stores the MAC address information and the IP address information of multiple appliances 3 connected to a local area network NW21 in a manner associated with the MAC address information of the control device 2001 connected to the local area network NW21. The appliance information storage 2232 stores, for each piece of MAC address information in the control device 2001, a combination of the IP address information, the type information, and the identification number for each of the multiple appliances 3 in a manner associated with the MAC address information of the appliance 3. The appliance state storage 2233 stores the above parameter information about each appliance 3 in a manner associated with the type information and the identification number of the appliance 3.

When acquiring the appliance information notification transmitted from the control device 2001, the update notification acquirer 2214 extracts the type information, the identification number, and the IP address information of the appliance 3 included in the acquired appliance information notification, and provides the information to the appliance information updater 2217. When acquiring the address notification transmitted from the control device 2001, the address acquirer 2218 extracts the MAC address information of the appliance 3 included in the acquired address notification, and provides the information to the appliance information updater 2217.

When receiving, from the update notification acquirer 2214, the type information, the identification number, and the IP address information of the appliance 3, the appliance information updater 2217 causes the appliance information storage 2232 to store, in a manner associated with the MAC address information provided from the address acquirer 2218, the received information.

When acquiring the appliance state information transmitted from the control device 2001, the encapsulated-message acquirer 2215 provides the acquired appliance state information to the decapsulator 2216. The decapsulator 2216 extracts the parameter information and the type information and the identification number of the appliance 3 included in the appliance state information provided by the encapsulated-message acquirer 2215, and causes the appliance state storage 2233 to store, in a manner associated with one another, the extracted parameter information and the extracted type information and identification number of the appliance 3.

The appliance controller 2213 determines whether the control details of the appliance 3 are to be updated based on the appliance state information of each appliance 3 stored in the appliance state storage 2233. When determining that the control details of the appliance 3 are to be updated, the appliance controller 2213 generates control information corresponding to the updated appliance control details based on at least one of the type information or the appliance identification information of the control target appliance 3 stored in the appliance information storage 2232. The appliance controller 2213 then provides the generated control information to the encapsulator 2211 together with the IP address information and the MAC address information of the appliance 3, as a transmission destination of the control information, stored in the appliance information storage 2232.

When receiving the control information, the IP address information, and the MAC address information of the appliance 3 from the appliance controller 2213, the encapsulator 2211 adds, to the received control information, header information specifying the control device 2001 as a transmission destination for encapsulation and generates a control notification, and provides the encapsulated control notification to the encapsulated-message transmitter 2212. The encapsulated-message transmitter 2212 transmits the received control notification to the control device 2001.

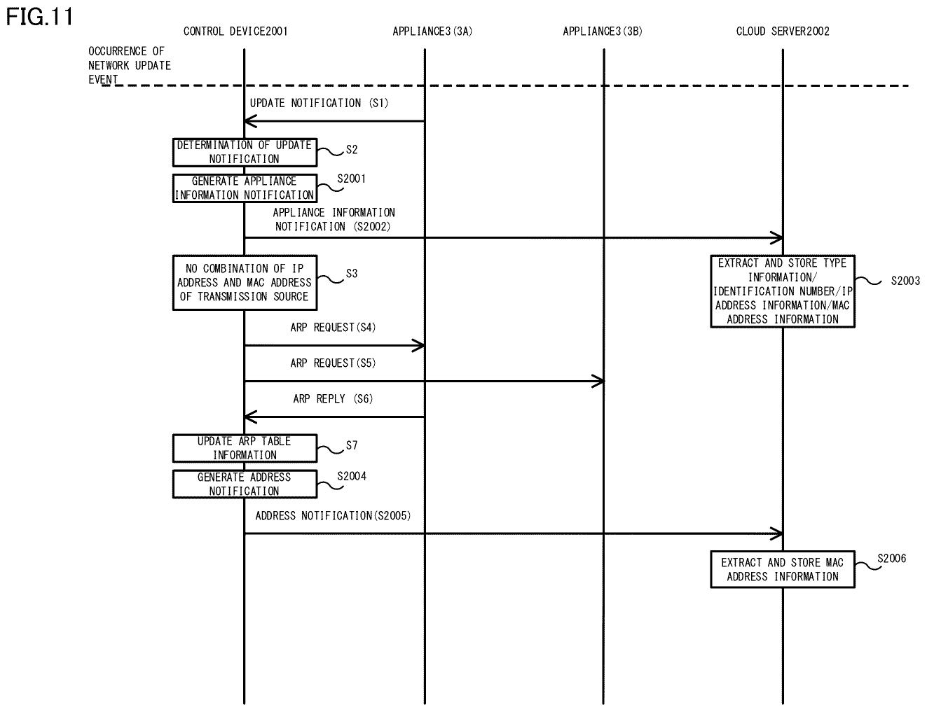

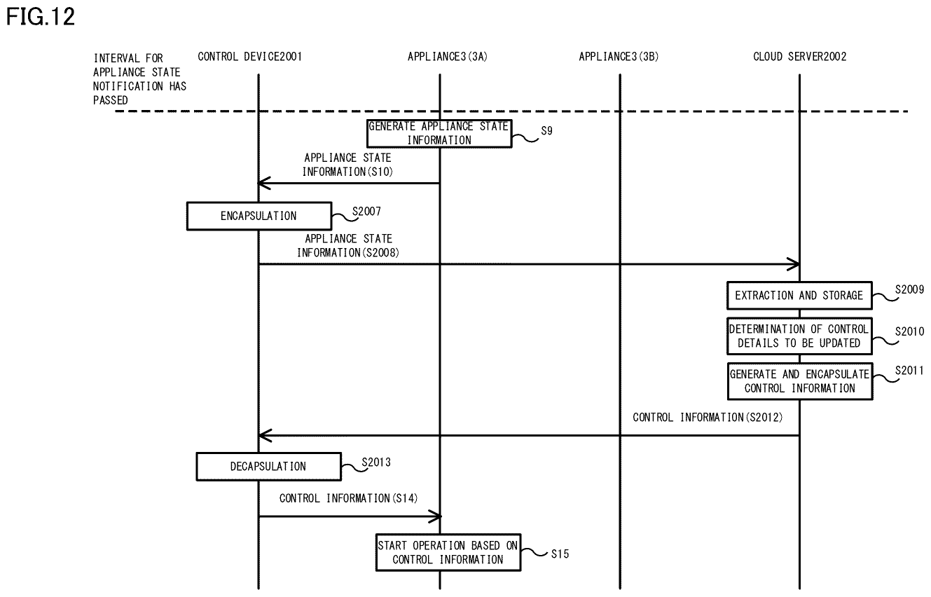

The operation of the control system according to the present embodiment is now described with reference to FIGS. 11 and 12. In this embodiment, the control device 2001 communicates with the appliances 3A and 3B, and the cloud server 2002. In FIGS. 11 and 12, like reference signs denote like processes in Embodiment 1 in FIG. 5. The network update event described above occurs first. In this case, an update notification indicating that the IP address is updated is transmitted from the appliance 3A to the control device 2001 (step S1). The control device 2001 determines that the appliance message transmitted from the appliance 3A is an update notification (step S2), and generates an appliance information notification including the type information, the identification number information, and the IP address information of the appliance 3A included in the update notification (step S2001). The generated appliance information notification is then transmitted from the control device 2001 to the cloud server 2002 (step S2002). When acquiring the appliance information notification, the cloud server 2002 extracts the type information, the identification number, and the IP address information of the appliance 3A included in the acquired appliance information notification, and causes the appliance information storage 2232 to store the extracted information in a manner associated with one another (step S2003).

The control device 2001 also refers to the ARP table information stored in the ARP table storage 131 and determines that no combination of the IP address and the MAC address of the appliance 3A as a transmission source of the update notification is included (step S3). In this case, the above ARP request is broadcast from the control device 2001 to the appliance 3A and the appliance 3B (steps S4 and S5). When acquiring the ARP request, the appliance 3A as a transmission source of the update notification transmits an ARP reply including the MAC address information of the appliance 3A to the control device 2001 (step S6). When acquiring the ARP reply, the control device 2001 extracts the MAC address information of the appliance 3A as a transmission source of the update notification included in the acquired ARP reply, and updates the ARP table information stored in the ARP table storage 131 with the extracted MAC address information (step S7). The control device 2001 then generates address notification including the extracted MAC address information (step S2004) and transmits the generated address notification to the cloud server 2002 (step S2005). When acquiring the address notification, the cloud server 2002 extracts the MAC address information included in the acquired address notification and causes the appliance information storage 2232 to store the extracted MAC address information in a manner associated with the type information, the identification number, and the IP address information of the appliance 3A (step S2006).

As illustrated in FIG. 12, when the interval for the appliance state notification has passed as described above, the appliance 3A generates the above appliance state information (step S9) and transmits the generated appliance state information to the control device 2001 (step S10). When acquiring the appliance state information, the control device 2001 adds header information for transmitting the acquired appliance state information to the cloud server 2002 and encapsulates the appliance state information (step S2007). The control device 2001 then transmits the encapsulated appliance state information to the cloud server 2002 (step S2008). When acquiring the appliance state information, the cloud server 2002 extracts the parameter information, the type information, and the identification number of the appliance 3A included in the acquired appliance state information, and causes the appliance state storage 2233 to store the extracted information in a manner associated with one another (step S2009).

The cloud server 2002 then determines to update the control details of the appliance 3A based on the appliance state information stored in the appliance state storage 2233 (step S2010). In this case, the cloud server 2002 generates control information corresponding to the updated appliance control details, adds header information for transmitting the generated control information to the control device 2001, and encapsulates the control information (step S2011). The cloud server 2002 then transmits the encapsulated control information to the control device 2001 (step S2012). When acquiring the encapsulated control information, the control device 2001 removes the header information added to the acquired control information and decapsulates the control information (step S2013). The control device 2001 then transmits the decapsulated control information to the appliance 3A using the MAC address indicated by the MAC address information of the appliance 3A (step S14). When acquiring the control information, the appliance 3A starts operation based on the acquired control information (step S15).

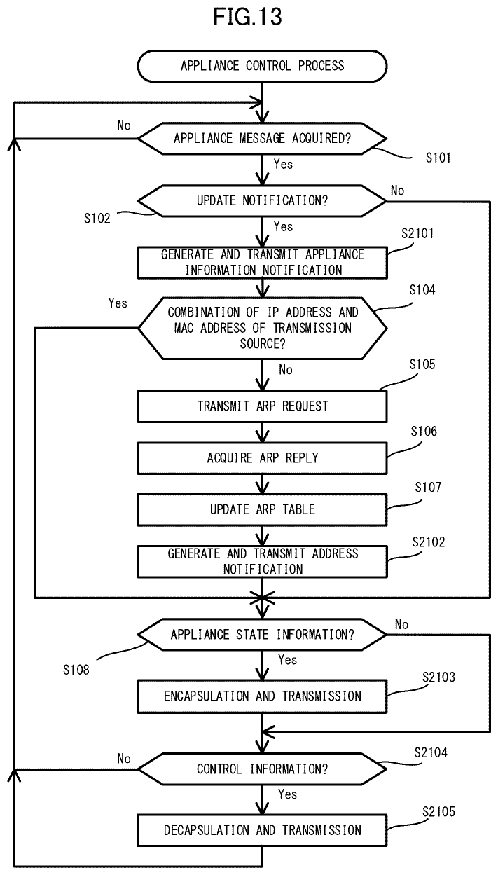

An appliance control process performed by the control device 2001 according to the present embodiment is now described with reference to FIG. 13. In FIG. 13, like reference signs denote like processes in Embodiment 1 in FIG. 6. The appliance message acquirer 2111 first determines that an appliance message transmitted from the appliance 3 is acquired in step S101 (Yes in step S101), and the message type determiner 2112 determines that the acquired appliance message is the above update notification (Yes in step S102). In this case, the message type determiner 2112 extracts the type information and the identification number of the appliance 3 included in the acquired update notification and provides the extracted information to the update notifier 2119, and also provides the IP address information of the appliance 3 as a transmission source of the update notification to the update notifier 2119. The update notifier 2119 then generates an appliance information notification including the type information, the identification number, and the IP address information of the appliance 3 provided from the message type determiner 2112, and transmits the appliance information notification to the cloud server 2002 (step S2101).

The MAC address identifier 114 then refers to the ARP table information stored in the ARP table storage 131 in step S104, and determines that no combination of the IP address and the MAC address of the appliance 3 as a transmission source of the update notification is included (No in step S104). After the processing in steps S105 to S107 is performed, the address notifier 2118 extracts, from the ARP reply provided from the MAC address acquirer 2115, the MAC address information of the appliance 3 as a transmission source of the ARP reply, generates an address notification including the extracted MAC address information, and transmits the address notification to the cloud server 2002 (step S2102).

When determining in step S102 that the appliance message is not an update notification (No in step S102), the message type determiner 2112 determines whether the appliance message is appliance state information (step S108). In this case, when the message type determiner 2112 determines that the appliance message is not appliance state information (No in step S108), the processing in step S2104 (described later) is performed. In contrast, when determining that the appliance message is appliance state information (Yes in step S108), the message type determiner 2112 provides the appliance state information to the encapsulator 2120. The encapsulator 2120 then adds header information for transmitting the appliance state information to the cloud server 2002 and encapsulates the appliance state information. The appliance message transmitter 2116 then transmits the encapsulated appliance state information to the cloud server 2002 (Step S2103).

The message type determiner 2112 then determines whether the appliance message is encapsulated control information (step S2104). When the message type determiner 2112 determines that the appliance message is not encapsulated control information (No in step S2104), the processing in step S101 is performed again. In contrast, when determining that the appliance message is encapsulated control information (Yes in step S2104), the message type determiner 2112 provides the control information to the decapsulator 2117. The decapsulator 2117 then removes the header information from the encapsulated control information and decapsulates the information to extract the MAC address information and the control information of the appliance 3 as a transmission destination of the control information. The appliance message transmitter 2116 then transmits the control information to the appliance 3 using the extracted MAC address information (step S2105). The processing in step S101 is then performed again.

As described above, in the control system according to the present embodiment, the cloud server 2002 including the appliance information storage 2232, the appliance state storage 2233, and the appliance controller 2213 can simplify the functional components of the control device 2001. This thus reduces the processing load on the control device 2001.

Although the embodiments of the present disclosure are described above, the present disclosure is not limited to the above embodiments. For example, the update notification may be a message complying with a standard other than ECHONET Lite (registered trademark) standard.

In each embodiment, the MAC address acquirer 115 or 2115 may transmit a dummy appliance message to each appliance 3 to broadcast the ARP request to the appliances 3.

The functions of the control device 1 or 2001 and the cloud server 2002 according to one or more embodiments of the present disclosure may be implemented by software, firmware, or a combination of software and firmware. In this case, the software or the firmware is written as programs, and the programs may be stored in a non-transitory computer-readable recording medium for distribution, such as a flexible disk, a compact disc ROM (CD-ROM), a digital versatile disc (DVD), or a magneto-optical (MO) disk. The programs may be installed in a computer to provide a computer that can implement the above functions. When the functions are shared by the operating system (OS) and applications or implemented through cooperation between the OS and applications, the programs other than the OS may be stored in the non-transitory recording medium.

Further, programs may be superimposed on a carrier wave to be distributed with a communication network. For example, the programs may be posted in a bulletin board system (BBS) on a communication network and distributed through the network. The programs may be started and executed similarly to other application programs under the control of the OS to perform the processing described above.

### INDUSTRIAL APPLICABILITY

The control device according to one or more embodiments of the present disclosure is suitable as a control system with a home energy management system (HEMS) installed in a house.

1. A control device for controlling an appliance by transmitting, to the appliance, control information for controlling the appliance using a static address specific to the appliance in a network including the appliance, the control device comprising:
a table storage to store table information associating the static address with a dynamic address assigned to the appliance in the network including the appliance;
an appliance information storage to store, in a manner associated with static address information indicating the static address and being specific to the appliance, type information indicating a type of the appliance and appliance identification information identifying the appliance in an application layer; and
processing circuitry to
identify the static address of the appliance based on the table information,
transmit an appliance message to the appliance using the identified static address,
transmit, to the appliance corresponding to a combination of the dynamic address and the static address not included in the table information, a static address request requesting transmission of the static address information to acquire the static address information, and add the static address information to the table information,
acquire the appliance message transmitted from the appliance,
determine whether the acquired appliance message is an update notification indicating assignment of a new dynamic address to the appliance,
generate the control information based on at least one of the type information or the appliance identification information, and
update the type information, the appliance identification information, and the static address information that are stored in the appliance information storage,
wherein the update notification includes the type information and the appliance identification information, and
the processing circuitry
transmits the static address request to the appliance that is a transmission source of the update notification to acquire the static address information from the appliance, and adds the static address information to the table information,
transmits the control information to the appliance using the static address information associated with the type information and the appliance identification information corresponding to the generated control information and stored in the appliance information storage, and
when the update notification is acquired, causes the appliance information storage to store, in a manner associated with one another, the type information and the appliance identification information included in the acquired update notification and the acquired static address information.

2-3. (canceled)

4. A control system, comprising:
a server to generate control information to control an appliance; and
a control device to control the appliance by transmitting, to the appliance, the control information acquired from the server using a static address specific to the appliance in a network including the appliance, wherein
the control device includes
a table storage to store table information associating the static address with a dynamic address assigned to the appliance in the network including the appliance, and
first processing circuitry to
identify the static address of the appliance based on the table information,
transmit an appliance message to the appliance using the identified static address,
transmit, to the appliance corresponding to a combination of the dynamic address and the static address not included in the table information, a static address request requesting transmission of static address information indicating the static address to acquire the static address information, and add the static address information to the table information,
acquire the appliance message transmitted from the appliance,
determine whether the acquired appliance message is an update notification
indicating assignment of a new dynamic address to the appliance,
transmit the acquired static address information to the server, and
transmit the update notification to the server,
the server includes
an appliance information storage store, in a manner associated with the static address information specific to the appliance, type information indicating a type of the appliance and appliance identification information identifying the appliance in an application layer, and
second processing circuitry to
generate the control information based on at least one of the type information or the appliance identification information, and
update the type information, the appliance identification information, and the static address information that are stored in the appliance information storage,
the update notification includes the type information and the appliance identification information,
the first processing circuitry
transmits the static address request to the appliance that is a transmission source of the update notification to acquire the static address information from the appliance, and adds the static address information to the table information, and
transmits the control information to the appliance using the static address information associated with the type information and the appliance identification information corresponding to the generated control information and stored in the appliance information storage, and
the second processing circuitry causes the appliance information storage to store, in a manner associated with one another, the type information and the appliance identification information included in the update notification transmitted by the first processing circuitry and the static address information transmitted by the first processing circuitry.

5-6. (canceled)

7. A control method for controlling an appliance by transmitting, to the appliance, control information for controlling the appliance using a static address specific to the appliance in a network including the appliance, the method comprising:
identifying, with a control device, the static address of the appliance based on table information stored in a table storage, the table information associating the static address with a dynamic address assigned to the appliance in the network including the appliance;
transmitting, with the control device, an appliance message to the appliance using the identified static address;
acquiring, with the control device, the appliance message transmitted from the appliance;
determining, with the control device, whether the acquired appliance message is an update notification that includes type information indicating a type of the appliance and appliance identification information identifying the appliance in an application layer and indicates assignment of a new dynamic address to the appliance;
transmitting, with the control device, to the appliance that is a transmission source of the update notification corresponding to a combination of the dynamic address and the static address not included in the table information, a static address request requesting transmission of static address information indicating the static address to acquire the static address information, and adding, with the control device, the static address information to the table information;
generating the control information based on at least one of the type information or the appliance identification information;
updating, with the control device, the type information, the appliance identification information, and the static address information that are stored in an appliance information storage, the appliance information storage storing, in a manner associated with the static address information specific to the appliance, the type information and the appliance identification information;
transmitting, with the control device, the control information to the appliance using the static address information associated with the type information and the appliance identification information corresponding to the generated control information and stored in the appliance information storage; and
when the update notification is acquired, causing, with the control device, the appliance information storage to store, in a manner associated with one another, the type information and the appliance identification information included in the acquired update notification and the acquired static address information.

8. A non-transitory computer-readable recording medium storing a program, the program causing a computer to function as:
processing circuitry to
identify a static address of an appliance based on table information stored in a table storage in a network including the appliance, the table information associating the static address specific to the appliance with a dynamic address assigned to the appliance in the network including the appliance,
transmit an appliance message to the appliance using the identified static address,
transmit, to the appliance corresponding to a combination of the dynamic address and the static address not included in the table information, a static address request requesting transmission of static address information indicating the static address to acquire the static address information, and add the static address information to the table information,
acquire the appliance message transmitted from the appliance,
determine whether the acquired appliance message is an update notification indicating assignment of a new dynamic address to the appliance,
generate control information for controlling the appliance, based on at least one of type information indicating a type of the appliance or appliance identification information identifying the appliance in an application layer, and
update the type information, the appliance identification information, and the static address information that are stored in an appliance information storage, the appliance information storage storing, in a manner associated with the static address information specific to the appliance, the type information and the appliance identification information,
wherein the update notification includes the type information and the appliance identification information, and
the processing circuitry
transmits the static address request to the appliance that is a transmission source of the update notification to acquire the static address information from the appliance, and adds the static address information to the table information,
transmits the control information to the appliance using the static address information associated with the type information and the appliance identification information corresponding to the generated control information and stored in the appliance information storage, and
when the update notification is acquired, causes the appliance information storage to store, in a manner associated with one another, the type information and the appliance identification information included in the acquired update notification and the acquired static address information.
